(19) United States
(12) Patent Application Publication
(10) Pub. No.: US 2024/0188529 A1
(43) Pub. Date: Jun. 13, 2024

(54) ATTACHABLE SYSTEM FOR AUTOMATING ANIMAL SHELTERS

(71) Applicant: Shireware LLC, Garrison, KY (US)

(72) Inventors: Thomas H. Massie, Garrison, KY (US); Hans D. Høeg, Vancouver, WA (US); Rhonda K. Massie, Garrison, KY (US); Collie E. Crawford, Louisville, KY (US)

(21) Appl. No.: 18/533,808

(22) Filed: Dec. 8, 2023

Related U.S. Application Data
(60) Provisional application No. 63/386,555, filed on Dec. 8, 2022.

(51) Int. Cl. A01K 1/00; A01K 5/02

(52) U.S. Cl. CPC A01K 1/0035; A01K 5/02

(57) ABSTRACT

An apparatus for automatically moving an animal enclosure, including a base, which is attachable to the animal enclosure, a motive system that is mounted to the base, an electronic control unit that is mounted to the base for controlling the motive system, a power source that is electrically connected with the motive system and the electronic control unit, and a light sensor that is electrically connected with the electronic control unit. The electronic control unit is configured to actuate the motive system only while the light sensor detects day light.

### CROSS-REFERENCE TO RELATED APPLICATIONS

This disclosure claims the benefit, under 35 U.S.C. § 119(e), of U.S. Provisional Application No. 63/386,555, filed on Dec. 8, 2022, the contents of which are incorporated herein by reference in their entirety.

### TECHNICAL FIELD

The present technology relates to management of animals. More particularly, the present technology relates to automated systems for the movement of animal shelters.

### BACKGROUND

Persons involved in domestic farming operations regularly make use of animal enclosures, such as chicken coops. Housing animals, and protecting animals from predators, while at the same time providing a healthy, nourishing environment is a challenging problem. Typically, it is solved by providing a type of enclosure to keep the animals in and safe from predators. One problem with stationary enclosures is that the ground under the enclosure will become messy with excrement and must be cleaned regularly, a time-consuming and unpleasant process, and one of the main reasons people give up on keeping chickens. Another problem is that the coop can become a vector for diseases. Further, healthy, fresh grass and bugs are a key to quality eggs and meat. Many farmers refuse to raise chickens on dirt and go to laborious, expensive lengths to provide grass.

Accordingly, there may be a need to physically move the animal enclosure to another location. Moving an animal enclosure may have the benefit of providing protection from predators. Moving the animal enclosure may also allow for greater ease of cleaning and maintenance of the grounds. Further, moving animal enclosures may provide the animals inside with greater protection from diseases. Therefore, there is a need for devices that allow for movement of animal enclosures.

Methods known in the prior art for moving animal enclosures often require the use of a human operator to operate machinery to move the animal enclosure. For example, a “mobile chicken tractor” is a coop constructed with a set of wheels, such that an operator can manually lift the opposite end to move the coop, akin to a wheelbarrow. However, this solution has the drawback that it is time consuming and labor intensive.

There have been attempts in the prior art to automate the movement of animal shelters. These attempts, suffer from numerous drawbacks, including:

Unless they are hooked up to a tractor or other type of pulling vehicle, which is expensive and time-consuming, they are often in the form of motorized assemblies, typically involve the use of driven wheels, which are prone to getting stuck in varying terrain. These motorized assemblies must have an open bottom to allow access to grass, which means that the walls of the corral must be as low to the ground as possible to keep predators out. This causes the corrals to get stuck, and at times they can even get high-centered, where the wheels end up without ground contact.

The weight, size, complexity, and cost of many self-moving corrals do not work for budget farmers and small-scale producers, or for families simply interested in producing their own food.

These motorized assemblies are often heavy, mechanically complicated, and expensive, such that they might require costly maintenance. Further, these motorized assemblies often injure animals inside the shelter when they are in motion, e.g., an animal's limb may get trapped underneath one of the walls of the assembly and the ground while it is motion.

The aforementioned problems notwithstanding, if it is possible to develop a system which reduces the labor associated with pastured animal husbandry, there are substantial financial gains to be had. In the case of raising broilers for example, production labor can account for more than 20% of the total cost. With net profits from raising pastured birds ranging from around 3-20%, depending on type of bird and raising standard (e.g., pastured, non-GMO pastured, organic), such a cost reduction could improve profits substantially. By certain industry metrics, a unit reduction in labor costs could lead to a five- to ten-fold increase in enterprise value.

### SUMMARY

The needs set forth herein as well as further and other needs and advantages are addressed by the present embodiments, which illustrate solutions and advantages described below.

The present technology provides systems for sustainable, environmentally conscious, safe, healthy, and disease-free animal husbandry while yielding better food products and reducing labor costs. Specifically, it provides users with a system for automating an animal enclosure that requires minimal cleaning or maintenance, helps fertilize the ground, does not get stuck, and is lightweight.

The present technology provides users with a shelter-moving system that can be attached to most any pre-existing shelter to make the shelter automatically self-propelled by motion that is safe for the sheltered animals. The system also provides facilities to energize an electric fence and actuate an automatic feeding mechanism.

Advantageously, the present technology moves the shelter when the animals are awake and capable of moving with the shelter, but does not move the shelter when the animals are asleep and thereby might be endangered by moving the shelter.

Advantageously, an embodiment of the present technology moves the shelter across the ground without resorting to wheeled propulsion and thereby mitigates any problems with lack of traction.

These and other objects of the present teachings are achieved by providing an apparatus for automatically moving an animal enclosure, the apparatus comprising a base, which is attachable to the animal enclosure, a motive system that is mounted to the base, an electronic control unit that is mounted to the base for controlling the motive system a power source that is electrically connected with the motive system and the electronic control unit, and a light sensor that is electrically connected with the electronic control unit, wherein the electronic control unit is configured to actuate the motive system only while the light sensor detects day light.

The present teachings also provide an apparatus for automatically moving an animal enclosure, the apparatus comprising a base, wherein the base is fastened to the animal enclosure, a first actuator mounted to the base, at least one rotatable element connected to the first actuator, an electronic control unit mounted to the base for providing control of the at least one rotatable element, and a power source that is electrically connected with the motive system and the electronic control unit.

### BRIEF DESCRIPTION OF THE DRAWINGS

FIG. 1 shows an embodiment of the present technology when it is not attached to an animal shelter.

FIG. 2 shows an embodiment of the present technology when it is attached to an animal shelter.

FIG. 3 shows an embodiment of the present technology when it is attached to an animal shelter, and wherein the embodiment of the present technology includes a solar collector, an automatic feeding mechanism, and an electric fence.

FIG. 4 shows one embodiment of the base plate of the present technology.

### DETAILED DESCRIPTION

The present description illustrates the present technology by way of examples, not by way of limitation of the principles of the present technology. This description will enable one skilled in the art to make and use the technology, and describes several embodiments thereof, including what the inventors presently believe to be the best mode of carrying out the present technology.

The present teachings provide attachable apparatuses for automatically moving animal enclosures. It will be understood by a person having ordinary skill in the art that the terms “animal shelter”, “animal enclosure”, and “animal containment device” are synonymous with one another, as are plural forms thereof.

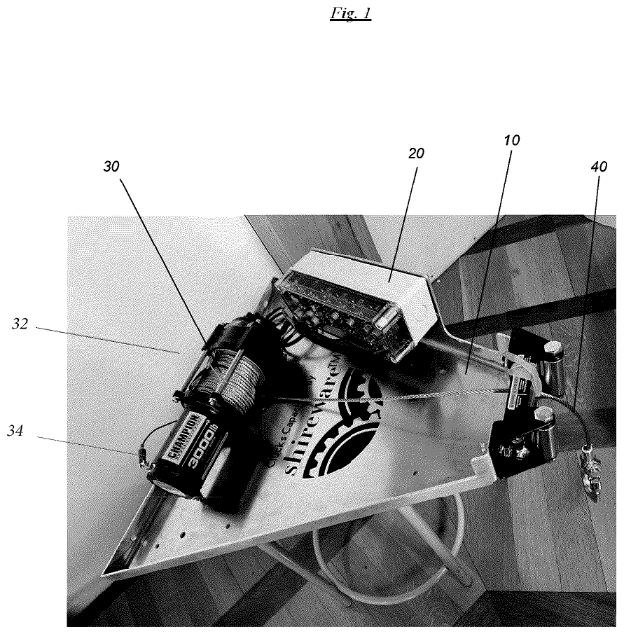

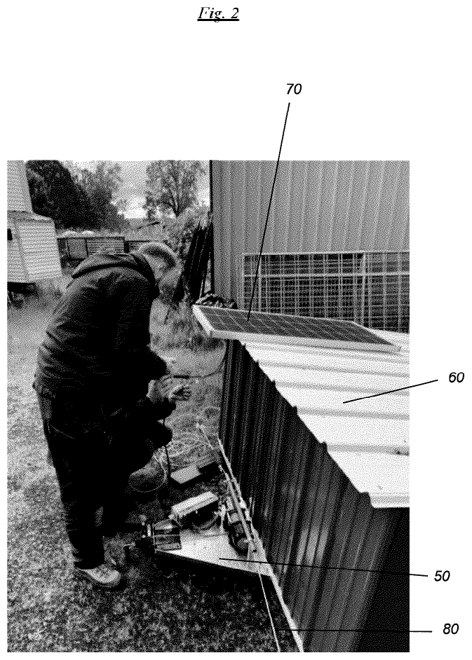

FIG. 1 illustrates an apparatus according to the preferred embodiment of the present teachings. As shown in FIG. 1, an animal shelter movement apparatus 50 is provided for attachment to a movable animal shelter. The apparatus includes a base plate 10, a motive system 30 (e.g., a pull-cable system), and an electronic control unit (ECU) 20. The base plate 10 is the part that may be attached to the animal shelter. The base plate 10 may be constructed out of any rigid material or combination of rigid materials, including metals such as steel or aluminum. The motive system 30, e.g., the pull-cable system, is the part that makes the apparatus move the animal shelter across the ground. The motive system 30 may be programmable to adjust speed. The pull-cable system 30 may include a cable 40 that is wrapped around a winch (a rotatable element) 32, which can be actuated by a winch motor (or actuator) 34. In other embodiments, the motive system may include one or more wheels, flippers, paddles, claws, limbs, or other structures that may engage against the ground to pull or push the animal enclosure. The electronic control unit 20 is the part that provides power to operate the motive system, e.g., to the winch motor 34 of the pull-cable system 30, according to computer-executable instructions that are implemented by the ECU. For example, the ECU 20 may provide power to operate the pull-cable system 30 in response to detecting day light, so that the apparatus does pull an animal shelter across the ground while the animals inside the shelter are awake, and does not pull the shelter across the ground while the animals inside the shelter are asleep. The ECU 20 may detect day light by operation of a photocell or solar panel, e.g., a solar panel 70 as shown in FIG. 2.

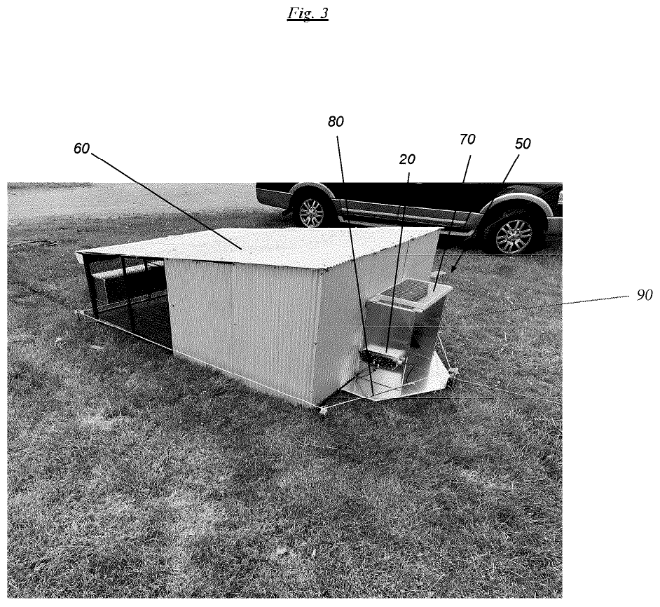

FIG. 2 illustrates an apparatus according to one embodiment of the present teachings. As shown in FIG. 2, the apparatus 50 having the pull-cable system 30 and the electronic control unit 20 is physically attached to an animal enclosure 60. The apparatus 50 may include more or fewer components. For example, the apparatus 50 may include a solar panel 70. The apparatus 50 also may include an automatic feeding mechanism 90, as shown in FIG. 3. The automatic feeding mechanism 90 may be mounted to the base plate 10 so as to dispense feed pellets into the animal enclosure adjacent to the apparatus, i.e. at a “leading edge” of the enclosure or the side toward which the apparatus will move the enclosure when the motive system is actuated.

In operation of the apparatus 50, the ECU 20 may sense day light and initiate a periodic actuation of the motive system 30. For example, the ECU 20 may energize the winch motor 34 during day light for intervals of time between one to five seconds, or more or less, at a speed of one to five cable-feet per minute, or more or less, with the distance intervals being spaced apart by one to five minutes or more or less. It is to be understood that intervals of time to energize the winch motor 34, intervals of winch motor 34 speed, and intervals of time between energizing the winch motor 34 may be changed independently of one another or connection with one another. The ECU 20 also may energize the winch motor 34 continuously during day light. Other intervals for the ECU 20 to energize the winch motor 34 are within the present teachings, including intervals which are programmable by a user. The winch motor 34 may also be actuated when day light is not available. During actuation of the motive system, the ECU 20 also may actuate the automatic feeding mechanism 90 in association with actuation of the motive system 30. For example, the ECU 20 may actuate the automatic feeding mechanism 90 before, immediately before, and/or during actuation of the motive system 30, so that feed pellets or the like are dispensed into the animal enclosure adjacent to the apparatus 50, thereby encouraging the occupants of the enclosure to move toward the apparatus 50 before and/or along with the motion of the enclosure toward the apparatus 50. In this context, “immediately before” means within one to five seconds preceding actuation of the motive system.

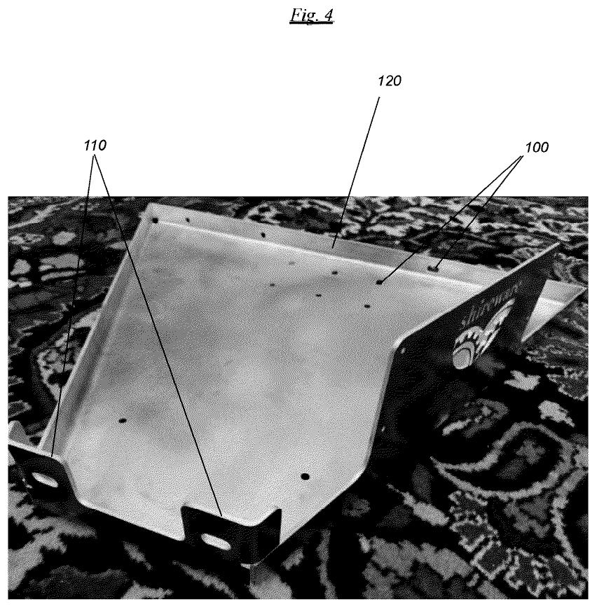

FIG. 4 illustrates a base plate 10 according to one embodiment of the present teachings. The base plate 10 preferably includes mounting brackets 110 for mounting winch fairleads or other guidance mechanisms for guiding a pull-cable system 30. The base plate includes a mounting surface 120, on which or through which may include one or more base plate holes 100.

The animal enclosure 60 can be in any form including, but without limitation, a chicken coop or a rabbit enclosure. The apparatus 50 is preferably directly attached to the animal enclosure 60, however, other forms of connection are within the scope of the present disclosure, including means such as an intermediary piece of material between the apparatus 50 and the animal enclosure 60. The physical connection between the apparatus 50 and the animal enclosure 60 may be accomplished by using one or more fasteners, including screws or bolts. The physical connection between the apparatus 50 and the animal enclosure 60 may be achieved by fastening the base plate 10 flush with the animal enclosure 60. The fastening of the base plate 10 flush with the animal enclosure 60 may be completed using the one or more base plate holes 100. The electronic control unit 20 may be powered using a solar panel 70, but it is to be understood that other forms of power may be utilized for the purpose of powering the electronic control unit 20, including without limitation, one or more batteries (not shown). The electronic control unit 20 and the solar panel 70 may be electrically connected or programmed such that activation of the solar panel 70 by a light source (e.g., the sun) is capable of causing the electronic control unit 20 to perform an operation. Operations according to the present teachings include, but are not limited to, movement of the pull-cable system 30 and dispensing feed from the automatic feeding mechanism 90.

Technology according to the present teachings may also include an electric fence wire 80. The electric fence wire 80 may be powered using the same power source that powers the electronic control unit 20 or using a separate power source. For example, the electric fence wire 80 may be powered by a solar panel 70 or another form of power, including without limitation, one or more batteries (which may be included within the electronic control unit 20). The electric fence wire 80 may be positioned in a manner whereby it encloses around the entirety of animal enclosure 60, including the apparatus 50 (as seen in FIG. 3). Alternatively, the electric fence wire 80 may be positioned in a manner whereby it encloses around a portion of the animal enclosure 60. The electric fence wire 80 may be continuously active (i.e., always energized), or it may be activated only upon the occurrence of conditions (e.g., when a solar panel 70 is active because of some light source, such as sunlight). The electric fence wire 80 may be controlled using the ECU 20, whereby the ECU 20 provides electrical signals to the electric fence wire 80.

The present technology has been described above in terms of an example embodiment so that an understanding of the present technology can be conveyed. However, many alternative ways of constructing the system are possible without departing from the principle of the present technology.

For example, the locomotion means does not have to be a winch, but may be, without limitation, wheels, paddles, or other means of providing propulsion. The scope of the present technology should therefore not be limited by the embodiments illustrated, but rather it should be understood that the present technology has wide applicability with respect to its stated objectives.

Also, the present technology extends to any animal that might fit with this situation, for example rabbits, or on a larger scale, livestock. All modifications, variations, or equivalent elements and implementations should therefore be considered within the scope of the claims.

What is claimed is:

1. An apparatus for automatically moving an animal enclosure, the apparatus comprising:
a base, which is attachable to the animal enclosure;
a motive system that is mounted to the base;
an electronic control unit that is mounted to the base for controlling the motive system;
a power source that is electrically connected with the motive system and the electronic control unit; and
a light sensor that is electrically connected with the electronic control unit,
wherein the electronic control unit is configured to actuate the motive system only while the light sensor detects day light.

2. The apparatus of claim 1, wherein the motive system comprises a pull-cable system.

3. The apparatus of claim 1, further comprising an electric fence wire that is controlled by the electronic control unit to activate upon the occurrence of a condition.

4. The apparatus of claim 1, further comprising an automatic feeding mechanism mounted to the base.

5. The apparatus of claim 1, wherein the power source comprises a solar panel.

6. The apparatus of claim 1, wherein the electronic control unit is configured to actuate the motive system at periodic intervals for intermittent low-speed motion.

7. The apparatus of claim 1, further comprising an automatic feeding mechanism that is configured to dispense feed into the animal enclosure, wherein the electronic control unit is configured to actuate the automatic feeding mechanism in association with actuation of the motive system.

8. The apparatus of claim 7, wherein the electronic control unit is configured to actuate the automatic feeding mechanism before actuation of the motive system.

9. An apparatus for automatically moving an animal enclosure, the apparatus comprising:
a base, wherein the base is fastened to the animal enclosure;
a first actuator mounted to the base;
at least one rotatable element connected to the first actuator;
an electronic control unit mounted to the base for providing control of the at least one rotatable element; and
a power source that is electrically connected with the motive system and the electronic control unit.

10. The apparatus according to claim 9, wherein the first actuator comprises a pull-cable system.

11. The apparatus according to claim 9, further comprising an electric fence wire that is controlled by the electronic control unit to activate upon the occurrence of a condition.

12. The apparatus according to claim 9, further comprising an automatic feeding mechanism that may be actuated using the electronic control unit.

13. The apparatus according to claim 9, wherein the power source comprises a solar panel.

14. The apparatus according to claim 13, wherein the solar panel can automatically trigger a response from the electronic control unit when activated by a light source.

15. The apparatus according to claim 9, wherein the electronic control unit is configured to actuate the motive system at periodic intervals for intermittent low-speed motion.
